(19) United States
(12) Patent Application Publication
(10) Pub. No.: US 2020/0111273 A1
(43) Pub. Date: Apr. 9, 2020

(54) USED CAR GRADE DIAGNOSTIC SYSTEM

(71) Applicant: KOREA ELECTRONICS TECHNOLOGY INSTITUTE, Seongnam-si (KR)

(72) Inventors: Young Ouk KIM, Bucheon-si (KR); Ha Gyeong SUNG, Suwon-si (KR); Hyung Su LEE, Seoul (KR); Se Woong JUN, Incheon (KR); Dong In SHIN, Goyang-si (KR)

(21) Appl. No.: 16/501,117

(22) Filed: Aug. 21, 2018

(51) Int. Cl. G07C 5/08; G06N 20/00; G06N 5/04; G07C 5/00

(52) U.S. Cl. CPC G07C 5/0808; G07C 5/008; G06N 5/04; G06N 20/00

(57) ABSTRACT

A system for diagnosing a grade of a used car according to an embodiment of the present invention includes: collecting basic information of a used car by using a module, and transmitting the same to a server; transmitting grade information of the used car to the server; securing big data within a database; securing an inference engine within the server by using enhanced learning information obtained by performing enhanced learning of relation between the basic information and a grade of the used car by using artificial intelligence; and collecting basic information of a used car to be diagnosed and transmitting the same to the server, and diagnosing a grade of the used car to be diagnosed based on the basic information of the used car to be diagnosed by using the inference engine.

### CROSS REFERENCE TO RELATED APPLICATION

The present application claims priority to Korean Patent Application No. 10-2017-0105663, filed. Aug. 21, 2017, the entire contents of which is incorporated herein for all purposes by this reference.

### BACKGROUND OF THE INVENTION

### Field of the Invention

The present invention relates generally to a system for diagnosing a grade of a used car on the basis of artificial intelligence.

### Description of the Related Art

In the Korean domestic used car market, used cars are traded on the basis of used car performance and status check records issued pursuant to Article 58, Paragraph 1 of the Automobile Management Act and Article 120, Paragraph 1 of the Enforcement Regulations of the same Act. However, performance and status check records are done by an inspector of each used car agency through a subjective decision.

Accordingly, a check record of the performance and status is provided to consumers during trading of a used car, the decision of the inspector who makes the check record of the performance and status may be wrong, and the check record of the performance and status is performed by inputting “good” or “proper”, and thus it is doubtful whether or not the check record has distinction or objectiveness.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Japanese Patent Application Publication No. 2016-004470 A

### SUMMARY OF THE INVENTION

Accordingly, the present invention has been made keeping in mind the above problems occurring in the related art, and the present invention is intended to provide a system for diagnosing a grade of a used car, the system being capable of: establishing big data by collecting major part information of a used car and a grade of the used car and storing the same in a database; performing, through artificial intelligence, enhanced learning for interring a grade of the used car by using the big data; and diagnosing the grade of the used car by using an inference engine.

A used car grade diagnosing system according to an embodiment of the present includes: a basic information transmission step of collecting basic information including information of a plurality of major parts of a used car and information of a year, a mileage, and a car type of the used car by using a module, and transmitting the same to a server; a grade information transmission step transmitting to the server grade information including a grade of the plurality of major parts and a grade of the used car based on the year, the mileage, and the car type of the used car; a big data securing step of storing the basic information and the grade information input to the server in a database, and securing big data within the database by repeating the basic information transmission step and the grade information transmission step for other used cars; an enhanced learning step securing an inference engine within the server by using enhanced learning information obtained by performing enhanced learning of a relation between the basic information and the grade of the used car by using artificial intelligence of an enhanced learning unit of the server based on the big data; and an inspection step collecting basic information of a used car to be diagnosed and transmitting the same to the server, and diagnosing, by the inference engine, a grade of the used car to be diagnosed based on the basic information of the used car to be diagnosed.

The grade information transmission step may divided into: a first grade information transmission step of transmitting to the server first grade information determined by a first inspector; and a second grade information transmission step of transmitting to the server second grade information determined by a second inspector.

The enhanced learning step may include: a first step of performing, by the enhanced learning unit, performing learning of a relation between information of the plurality of major parts of the used car and a grade of the plurality of major parts; a second step of performing, by the enhanced learning unit, performing learning of a relation between the grade of the plurality of major parts of the used car and the grade of the used car; and a weight setting step of setting a weight for the grade of each ma or part so as to infer the grade the used car from the grade of the plurality of major parts.

The inspection step may include: a major part grade inferring step of determining, by the inference engine, a grade of each major part of the used car to be diagnosed; and a used car grade inferring step of inferring the grade of the used car to be diagnosed in consideration of the grade of each major part of the used car to be diagnosed, and the weight.

The plurality of major parts of the used car and the plurality of major parts of the used car to be diagnosed may respectively include an engine, a transmission, a suspension system, a steering, and a brake system, and the grade of the plurality of major parts and the grade of the used car is classified into five grades.

The module may include: an image module collecting image information of the plurality of major part; a sound module collecting sound information of the plurality of major part; a non-destructive inspection module collecting non-destructive inspection information of the plurality of major part; and a vibration module collecting vibration information of the plurality of major part.

The enhanced learning step may include: a simulation step of providing basic information of a virtual used car from the database to a simulator, wherein the simulator is included in the server, and performing simulation of determining the grade of the used car based on the enhanced learning information of the enhanced learning unit; and a weight correcting step of storing simulation information obtained in the simulation step in the database, and correcting the weight of the grade of each major part set in the enhanced learning unit by using the simulation information.

According to the present invention configured as described above, enhanced learning can be performed by artificial intelligence by using big data established in the basic information transmission step and the grade transmission step, and a grade of the used car can be determined by using an inference engine. Accordingly, know-how of used car diagnosing expertise of specialists is applied to an intelligent system, and used for diagnosing the grade of the used car. As a result, objectiveness and distinction can be added to the grade of the used car.

In addition, by securing an inference engine within the server, a grade of the used car can be evaluated by artificial intelligence without intervention of a person.

In addition, by including a simulator in the server, autonomous simulation for evaluating a used car can be performed, without additional information, by using enhanced learning information obtained from an inference engine and the database within the server, and thus the artificial intelligence can enhance the inference engine by using simulation information obtained through the simulation.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a flow chart from starting to securing big data;

FIG. 2 is a view of a flowchart of transmission flow of information within a server;

FIG. 3 is a view of a conceptual diagram of diagnosing a grade of a used car to be diagnosed; and

FIG. 4 is a view of a flowchart from starting to output a grade of a used car after securing the big data.

### DETAILED DESCRIPTION OF THE INVENTION

The above and other objects, features and other advantages of the present invention will be more clearly understood from the following detailed description when taken in conjunction with the accompanying drawings. As for reference numerals associated with parts in the drawings, the same reference numerals will refer to the same or like parts throughout the drawings. In addition, it will be understood that, although the terms “one surface”, “another surface”, “first”, “second”, etc. may be used herein to describe various elements, these elements should not be limited by these terms. These terms are only used to distinguish one element from another element. In the description, details of well-known features and techniques may be omitted to avoid unnecessarily obscuring the presented embodiments.

Hereinbelow, exemplary embodiments of the present invention will be described in detail with reference to the accompanying drawings in which like reference numerals refer to like elements.

A used car grade diagnosing system 1 includes: a basic information transmission step S100 of collecting basic information 22 including information of a plurality of major parts 21 of a used car 2, and information including a year, a mileage, and a car type of the used car 2 by using a module 20, and transmitting the same to the server 10; a grade information transmission step S200 of transmitting to the server 10 grade information 23 including a grade of the plurality of major parts 21 and a grade of the used car on the basis of the year, the mileage, and the car type of the used car 2; a big data securing step S300 of storing the basic information 22 and the grade information 23 which are input to the server in a database 11, and securing big data 24 within the database 11 by repeating the basic information transmission step S100 and the grade information transmission step S200 for other used cars; a enhanced learning step S400 securing an inference engine 13 within the server 10 by using enhanced learning information 25 obtained by performing enhancing learning of a relation between the basic information 22 and the grade 23b of the used car by using artificial intelligence of an enhanced learning unit 12 within the server 10 on the basis of the big data; and an inspection step S500 of collecting basic information of a used car to be diagnosed 3 and transmitting the same to the server 10, and diagnosing a grade of the used car to be diagnosed on the basis of the basic information of the used car to be diagnosed by using the inference engine 13.

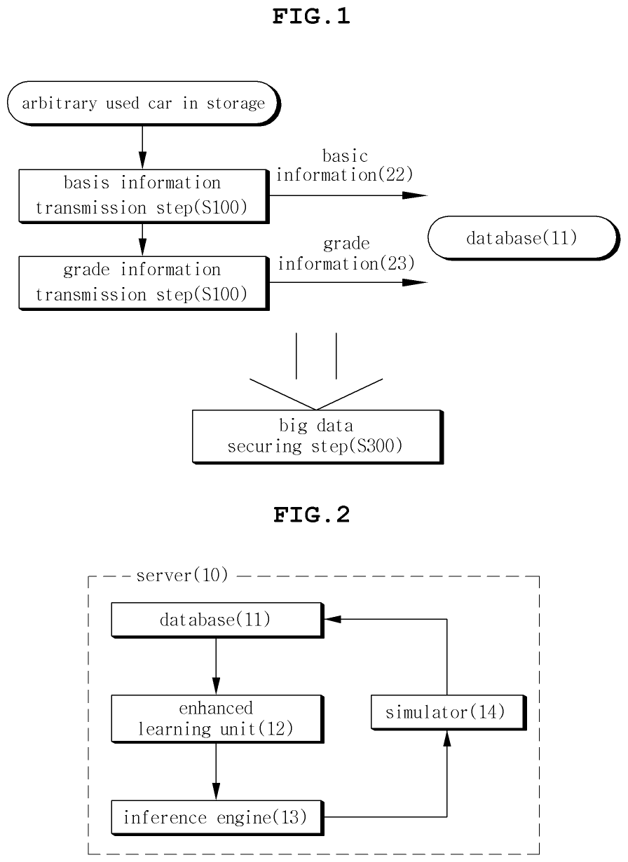

FIG. 1 is a view of a flowchart of securing big data of the present invention.

The present invention is an invention of evaluating a grade of a used car by using only major part information 22a of the used car, and thus securing major part information 22a of the used car is required. Accordingly, in the basic information transmission step S100, an inspector collects basic information 22 of a used car by using the module 20. The basic information 22 includes major part information 22a of the used car, and information of a year 22b, a mileage 22c, and a car type 22d of the used car. The basic information 22 is obtained by using the module 20, and the inspector wears the module 20 and measures the major part information 22a, that is, sound, image, vibration, non-destructive inspection information of the major parts of the used car. In addition, the inspector inputs the year 22b, the mileage 22c, and the car type 22d of the corresponding used car to the module, and the basic information is transmitted to the server 10 by the corresponding module.

In the grade information transmission step S200, the inspector evaluates a performance grade of the corresponding used car according to the year, the mileage, and the car type of the used car. According to the car type 22d of the used car, types of major part information 22a of the used car which is obtained by the module vary, so that classification by car type is required. First, basic information 22 is classified by car type, among information that is classified, a grade 23b of the used car is evaluated on the basis of a year and a mileage. When trading a used car, a reference price of the used car tends to be determined on the basis of a year and a mileage. Accordingly, by determining performance of the used car, the used car may be appraised with a price higher than the reference price when performance of the same is better when compared with the year and the mileage, or may be appraised with a price lower the reference price when performance of the same is worse when compared with the year and the mileage. Accordingly, the inspector evaluates a grade of the major part of the used car and a grade of the used car on the basis of the year, the mileage, and the car type of the used car, and the evaluated grade information is transmitted to the server.

TABLE 1

| | | | Mileage | Objective car | Grade of |
|---|---|---|---|---|---|
| Used car | Car type | Year | (km) | statues | the used car |
| A | Santa Fe | 3 | 3000 | Good | B |
| B | Santa Fe | 5 | 5000 | Ordinary | B |
| C | Santa Fe | 7 | 7000 | Inadequate | B |

TABLE 2

| | | | Mileage | Objective car | Grade of |
|---|---|---|---|---|---|
| Used car | Car type | Year | (km) | statues | the used car |
| D | Grandeur | 3 | 3000 | Good | B |
| E | Grandeur | 5 | 5000 | Ordinary | B |
| F | Grandeur | 7 | 7000 | Inadequate | B |

The above Tables 1 and 2 show an example of evaluating a grade 23b of a corresponding used car in comparison with a year 22b, a mileage 22c, and a car type 22d of the used car. First, major part information is significantly classified by car type. Herein, when a year is not old and a mileage of a used car is low, it is expected that a status of the used car is good. However, although an objective car status of the used car “A” and “D” is good, a grade of the used car may be evaluated to B. Alternatively, when a year is old and a mileage of a used car is high, it is expected that a status of the used car is not good. However, although an objective car status of the used “C” and “F” is inadequate, a grade of the used car may be evaluated to B.

In the big data securing step S300, basic information 22 and grade information 23 are stored in the database 11, and the basic information transmission step S100 and the grade information transmission step S200 are repeated. Accordingly, information of a plurality of used cars may be secured. The information of the used car may be obtained from workplaces such as used car repair workplaces, etc., and it may be expected to build big data by obtaining 200,000 pieces of information for 5 years.

FIG. 2 is a view showing a configuration of a server.

A server 10 includes a database 11, an enhancing learning unit 12, an inference engine 13, and a simulator 14. The server 10 is fundamentally operated through artificial intelligence. Artificial intelligence of the enhancing learning unit 12 processes basic information 22 stored in the database 11. Enhanced learning of a relation between basic information 22 and a grade 23b of the used car is performed. By performing the above enhanced learning, the inference engine 13 may be obtained where a grade 23b of a corresponding used car is inferred by inputting basic information of a used car to be diagnosed. The above obtaining the inference engine 13 is called the enhanced learning step S400. For enhanced learning of the enhanced learning step S400, artificial intelligence using a deep Q-network (DQN) method may be used.

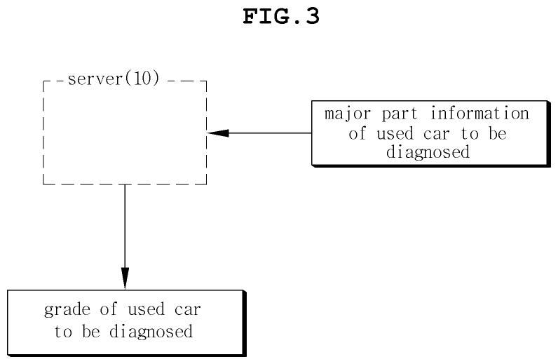

FIG. 3 is a view showing a data transmission flow in the inspection step S500.

The inference engine 13 secured as above is used for inferring a grade of a used car to be diagnosed 3 when basic information of a used car to be diagnosed 3 is transmitted to the server 10, and input to the inference engine 13. Evaluating a grade of the used car to be diagnosed 3 is called the inspection step S500.

In the used car grade diagnosing system 1 according to an embodiment of the present invention, the grade information transmission step S200 is divided into: a first grade information transmission step of transmitting first grade information determined by a first inspector: and a second grade information transmission step of transmitting second grade information determined by a second inspector.

The grade information transmission step is divided into a first step and a second step to obtain two pieces of grade information for the same used car. This is for adding a decision of the second inspector to compensate a subjective decision of the first inspector for a corresponding used car. In addition, the present invention is to infer a grade of a used car based on intelligence of know-how of expertise of specialists, and thus data may be secured faster when two pieces of grade information determined by an expert is given for one used car.

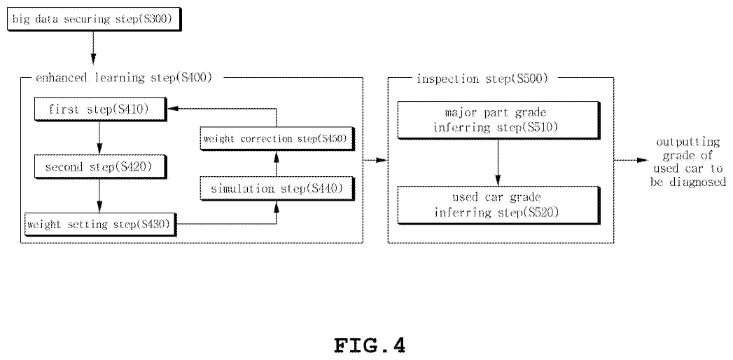

FIG. 4 is a view of a flowchart that shows in detail the enhanced learning step of the present invention.

In the used car grade diagnosing system 1 according to an embodiment of the present invention, the enhanced learning step S400 includes: a first step S410 of performing learning, by the enhancing learning unit 12, or a relation between basic information 22 of the used car and a grade 23a of a plurality of major parts 21; a second step S420 of performing learning, by the enhancing learning unit 12, of a relation between the grade 23a of the plurality of major parts 21 of the used car and the grade 23b of the used car; and a weight setting step S430 of setting, for the grade 23a of the plurality of major parts 21, a weight for the grade of each major part 21 to infer the grade 23b of the used car.

The first step S410 is a step of performing learning of, by the enhancing learning unit 12, a relation between the basic information 22 of the used car 2 which includes the major part information 22a and the information of the year 22b, the mileage 22c, and the car type 22d, and the grade 23a of the major parts. In other words, artificial intelligence of the enhancing learning unit 12 performs learning of a relation between image, sound, vibration or non-destructive inspection data of the used car, and the grade 23a of the corresponding used car so that the grade of the plurality of major parts 21 of the corresponding used car may be inferred by inputting the basic information 22 of the used car to the inference engine 13.

The second step S420 is a step of performing learning, by the enhanced learning unit 12, of a relation between the grade 23a of the plurality of major parts 21 of the used car 2 which include the major part information 22a and information of the year 22b, the mileage 22c, and the car type 22, grade 23b of the used car. In other words, by using grade information 23 of the database 11, performing learning of a relation between the plurality of major parts 21 and the used car is available.

TABLE 3

| | | | Grade | Grade | Grade | Grade |
|---|---|---|---|---|---|---|
| | Grade | Grade | of | of | of | of |
| Used | of | of | suspension | steering | brake | used |
| car | engine | transmission | system | system | system | car |
| G | A | B | C | D | E | B |
| H | E | D | A | A | A | C |
| I | A | A | B | B | B | A |

The relation between the plurality of major parts 21 and the used car to which learning is performed in the second step is used for setting a weight for the grade 23a of the plurality of major parts 21 in the weight setting step S430. In other words, when inferring a single grade of the used car in the inspection step S500 where the grade of the plurality of major parts 21 are combined, a weight for a grade of each major part 21 is set. Table 3 is a table showing a concept of the weight. In Table 3, major parts of a used car are configured with an engine, a transmission, a suspension system, a steering system, and a brake system. For example, for a used car “G” of Table 3, an average grade of major parts is evaluated to C, but a grade of the used car is evaluated to B. This may be understood that importance of the engine and the transmission is greater in the used car than other major parts. For a used car “H” of Table 3, grades of the suspension system, the steering system, and the brake system are evaluated to A, so that an average grade of the major parts is expected to be A. However, as weights for the engine and the transmission are set to be high, a grade of the used car “H” is evaluated to C. As described above, artificial intelligence sets a weight for each major part by performing learning of a relation between the grades 23a of the major parts of the used car, and the grade 23b of the used car. Set weights are used when the inference engine 13 of the server 10 processes basic information of a used car to be diagnosed 3.

In the used car grade diagnosing system 1 according to an embodiment of the present invention, the inspection step S500 includes: a major part grade inferring step S510 of determining, by the inference engine 13, a grade of each major part 21 of the used car to be diagnosed 3; and a used car grade inferring step S520 of inferring a grade of the used car to be diagnosed 3 in consideration of the weight, and the grade of each major part of the used car to be diagnosed 3.

The flowchart of FIG. 4 also shows in detail the inspection step S500.

The inference engine 13 is secured on the basis of enhanced learning information generated in the enhanced learning step, and a grade of each major part 21 of a used car to be diagnosed is inferred by using basic information of the used car to be diagnosed 3 by inputting the same to the inference engine 13. In addition, by using a weight of each major part 21 obtained from the enhanced learning unit 12, a grade of the used car to be diagnosed 3 may be inferred by using the grade of each major part 21 of the used car to be diagnosed 3.

In the used car grade diagnosing system 1 according to an embodiment of the present invention, the plurality of major parts 21 of the used car and the plurality of major parts 21 of the used car to be diagnosed 3 respectively include an engine, a transmission, a suspension system, a steering system, and a brake system, and a grade 23a of each major part and a grade 23b of the used car are divided into five grades.

The plurality of major parts 21 includes major parts determining performance of a car, and experts of used car dealing industry collect image, vibration, and sound information through the module 20, focusing on the major parts of a used car, such as an engine, a transmission, a suspension system, a steering system, and a brake system. In addition, a number of grades of the grade information 23 is set be five. By setting a number of grades to five, a consumer who is provided with printed result grades may easily evaluate a corresponding used car so as to add distinction to the grade of the used car, and the sever 10 may evaluate a grade without an error in consideration of information processing capability of the artificial intelligence.

In the used car grade diagnosing system 1 according to the present invention, the module 20 includes: an image module collecting image information of the major part; a sound module collecting sound information of the major part; a non-destructive inspection module collecting non-destructive inspection information of the major part; and a vibration module collecting vibration information of the major part.

For example, when determining a grade of each major part by appearance, and determining a grade of each major part by appearance and sound, more objectiveness may be added when more information is obtained when determining by using appearance and sound. Accordingly, the module 20 includes the image module collecting image information, the sound module collecting sound information, the non-destructive inspection module capable of performing non-destructive inspection and collecting data thereof, and the vibration module collecting vibration information. Thus, the corresponding module 20 collects information 22a of the major parts. Accordingly, information 22a of the major parts includes information of image, sound, non-destructive inspection, vibration, etc. As various types of information are secured, when securing big data, the decision of the inspector who is the subject of the decision may be more objective. In addition, artificial intelligence of the server may secure objectiveness of the inference engine by learning various types of information.

As types of information to be processed vary such as image, sound, etc., types of the artificial intelligence may vary. Convolutional neural network (CNN) series may be used for image information, and recurrent neural network (RNN) series may be used for sound and vibration information.

In the used car grade diagnosing system 1 according to an embodiment of the present invention, a simulator 14 is included in the server 10, the database 11 provides to the simulator 14 basic information of a virtual used car, and the enhanced learning step S400 further includes: a simulation step S440 of performing simulation for a grade decision of the used car on the basis of enhanced learning information of the enhanced learning unit 12; and a weight correction step S450 storing simulation information obtained in the simulation step S440 in the database 11, and correcting the weight for the grade of each major part of the enhancing learning unit 12 by using the simulation information.

FIG. 2 also shows an information transmission flow within the server 10 through the simulator 14, and FIG. 4 also shows correcting a weight by performing simulation in the enhanced learning step S400.

The server 10 includes the simulator 14. The simulator 14 performs learning autonomously by using basic information 22 and grade information 23 which are stored in the server 10 and without receiving additional information. Accordingly, basic information 22 of the database 11 is provided to the simulator 14, and the simulator 14 performs simulation learning that infers a grade of the used car by using the basic information 22. Simulation learning infers a grade of a virtual used car on the basis of enhanced learning information of the enhancing learning unit 12. Simulation is performed where simulation data is autonomously obtained without inputting new data, and the above process is called the simulation step S440.

Based on simulation information obtained in the simulation step S440 described as above, a weight is corrected in the weight correction step S450. In other words, simulation information obtained in the simulation step S440 is stored in the database 11. The simulation information is provided to the enhancing learning unit 12, and is used for correcting the weight set in the weight setting step S430. The above process is called the weight correcting step S450.

Accordingly, when new basic information 22 and grade information 23 are transmitted to the server 10 in the enhanced learning step S400, enhanced learning information may be obtained by sequentially performing the first step S410, the second step S420, and the weight setting step S430. In addition, even though new information is not transmitted, the simulation step S440 and the weight correction step S450 may be performed after the weight setting step S430 and before the first step S410, and thus the artificial intelligence autonomously performs enhanced learning as shown in the flowchart of the enhanced learning step S400 shown in FIG. 4.

Although exemplary embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A system for diagnosing a grade of a used car, the system comprising:
a basic information transmission step of collecting basic information including information of a plurality of major parts of a used car and information of a year, a mileage, and a car type of the used car by using a module, and transmitting the same to a server;
a grade information transmission step transmitting to the server grade information including a grade of the plurality of major parts and a grade of the used car based on the year, the mileage, and the car type of the used car;
a big data securing step of storing the basic information and the grade information input to the server in a database, and securing big data within the database by repeating the basic information transmission step and the grade information transmission step for other used cars;
an enhanced learning step securing an inference engine within the server by using enhanced learning information obtained by performing enhanced learning of a relation between the basic information and the grade of the used car by using artificial intelligence of an enhanced learning unit of the server based on the big data; and
an inspection step collecting basic information of a used car to be diagnosed and transmitting the same to the server, and diagnosing, by the inference engine, a grade of the used car to be diagnosed based on the basic information of the used car to be diagnosed.

2. The system of claim 1, wherein the grade information transmission step is divided into:
a first grade information transmission step of transmitting to the server first grade information determined by a first inspector; and
a second grade information transmission step of transmitting to the server second grade information determined by a second inspector.

3. The system of claim 1, wherein the enhanced learning step includes:
a first step of performing, by the enhanced learning unit, performing learning of a relation between information of the plurality of major parts of the used car and a grade of the plurality of major parts;
a second step of performing, by the enhanced learning unit, performing learning of a relation between the grade of the plurality of major parts of the used car and the grade of the used car; and
a weight setting step of setting a weight for the grade of each major part so as to infer the grade the used car from the grade of the plurality of major parts.

4. The system of claim 3, wherein the inspection step includes:
a major part grade inferring step of determining, by the inference engine, a grade of each major part of the used car to be diagnosed; and
a used car grade inferring step of inferring the grade of the used car to be diagnosed in consideration of the grade of each major part of the used car to be diagnosed, and the weight.

5. The system of claim 1, wherein the plurality of major parts of the used car and the plurality of major parts of the used car to be diagnosed respectively include an engine, a transmission, a suspension system, a steering system, and a brake system, and each of the grade of the plurality of major parts and the grade of the used car is classified into five grades.

6. The system of claim 1, wherein the module includes:
an image module collecting image information of the plurality of major parts;
a sound module collecting sound information of the plurality of major parts;
a non-destructive inspection module collecting non-destructive inspection information of the plurality of major parts; and
a vibration module collecting vibration information of the plurality of major parts.

7. The system of claim 3, wherein the enhanced learning step further includes:
a simulation step of providing basic information of a virtual used car from the database to a simulator, wherein the simulator is included in the server, and performing simulation of determining the grade of the used car based on the enhanced learning information of the enhanced learning unit; and
a weight correcting step of storing simulation information obtained in the simulation step in the database, and correcting the weight of the grade of each major part set in the enhanced learning unit by using the simulation information.
